(19) United States
(12) Patent Application Publication
(10) Pub. No.: US 2003/0084450 A1
(43) Pub. Date: May 1, 2003

(54) Method and system for presenting personalized television program recommendation to viewers

(76) Inventors: Nathaniel J. Thurston, Somerville, MA (US); Devin F. Hosea, Boston, MA (US); Thomas L. Renger, Cambridge, MA (US)

Correspondence Address: LUCASH, GESMER & UPDEGROVE, LLP, 40 BROAD ST, SUITE 300, BOSTON, MA, 02109, US

(21) Appl. No.: 10/269,849

(22) Filed: Oct. 11, 2002

Related U.S. Application Data
(60) Provisional application No. 60/336,270, filed on Oct. 25, 2001.

(51) Int. Cl. G06F 3/00; H04N 5/445; G06F 13/00

(52) U.S. Cl. 725/46; 725/51; 725/47

(57) ABSTRACT

A novel electronic program guide (EPG) based method and system provide viewers/users with an improved program recommendation feature for predicting programs that are likely to be of interest. Either by a user's decision, or default, when a user is presented with recommended programs, the recommended programs are derived from Recommended Program Information generated by the Service Provider. The Recommended Program Information is based upon the User Profile of the user receiving the Recommended Program Information, and the User Profiles of other users serviced by the Service Provider who have similar user characteristics. The User Profiles also contain viewing history information. Therefore, programs are recommended for viewing to a user for which other users with similar characteristics have demonstrated an actual of potential interest.

### PRIORITY CLAIM

The present application claims priority to co-pending Provisional Application Serial No. 60/336,270 entitled “Method and System for Presenting Personalized Television Program Recommendation to Viewers”, filed on Oct. 25, 2001, and having a common inventive entity.

### BACKGROUND OF THE INVENTION

1. Field of the Invention

The present invention generally relates to electronic program guides used to allow a viewer to select from a multitude of available programs.

2. Background

Electronic Program Guides (EPGs) are special graphical user interfaces (GUIs) that allow users to navigate through a multitude of programs available for viewing or reproduction. Many EPGs present one or more layered displays—often available on a dedicated television channel—to give a user an inventory of programs available for viewing or reproduction, as well as schedules and other details (e.g., channels, program length, program synopsis, etc.) about the programs. Pointing devices are often used to control and navigate within the displays, as well as to activate links to the programs of interest. EPGs are especially useful for television viewers who receive a great deal of television stations, as is increasingly the case with cable and satellite television subscribers.

One common complaint of prior art EPGs is that they are not very helpful to viewers/users who are not sure about which program to view. While the displays may be attractively arranged, the user must still often sift through a great deal of information, making the process of locating a desirable program time-consuming, boring and intimidating for the “technologically challenged.”

Some of the Electronic Program Guide literature has begun to disclose EPGs that use a set-top box to keep a viewing history of the associated user. It has been proposed that the viewing history stored in the set-top box be used to recommend programs that might be of interest to the user in his or her current viewing session. For example, if the viewing history indicates that motion pictures of the “western” genre have been frequently viewed, the EPG might find western movies which are currently playing or scheduled to play in the future to list (e.g., in order of most to least likely to be of interest) for the user in either a Recommended Programs area or in a separate display.

This approach might be useful where the user viewing history has existed for a long time, and where the user frequently watches a great number of programs. This approach has limited value for users who have newly established viewing histories, and those who might not watch a large number of programs. Also, relying only on the user's own viewing history, there is a large chance that programs that may in fact be of interest will not have been previously viewed, and will therefore not be recommended for current or near-future viewing.

What is therefore desirable but non-existent and not suggested in the prior art, is an EPG which recommends programs, wherein the recommendations are made with information not limited to the user and his/her viewing history, in order to consider a wider variety of programs that may in fact be of interest.

What is also desirable is an EPG that recommends programs at least in part on the basis of provider- or advertiser-based preferences; i.e., an EPG that enables the system to inject a user-imperceptible preference or “bias” into the recommendation process, in return for payment or other consideration received by the system operators.

### SUMMARY OF THE INVENTION

In view of the aforementioned problems and deficiencies of the prior art, the present invention provides a program navigation method for, via an Electronic Program Guide (EPG), enabling a program viewer/user to locate and link to programs. The method at least includes the steps of: via a service provider, providing a source of multiple programs; via the service provider, gathering viewing history information regarding a plurality of viewers/users serviced by the service provider; and storing viewer/user profiles having viewer/user characteristic information and indicia of programs previously viewed by viewers/users serviced by the service provider. The method also at least includes the step of providing program recommendation information to users, the program recommendation information being adapted to be converted and displayed via an EPG, and the program recommendation information at least including one program recommendation based upon a user's profile and at least one user profile of another user having predefined similarities in at least one user characteristic.

The present invention also provides a program navigation system for, via an EPG, enabling a program viewer/user to locate and link to programs. The system at least includes: a service provider adapted to provide a source of multiple programs; a viewing history information gatherer adapted to gather viewing history information regarding a plurality of viewers/users serviced by the service provider; and viewer/user profile storage adapted to store viewer/user profiles having viewer/user characteristic information and indicia of programs previously viewed by viewers/users serviced by the service provider. The system also at least includes a program recommendation information generator adapted to generate program recommendation information to users, the program recommendation information being adapted to be converted and displayed via an EPG, and the program recommendation information at least including one program recommendation based upon a user's profile and at least one user profile of another user having predefined similarities in at least one user characteristic.

A further aspect of the invention is an EPG that recommends programs at least in part on the basis of provider- or advertiser-based preferences; i.e., an EPG that enables the system to inject a user-imperceptible preference or “bias” into the recommendation process, in return for payment or other consideration received by the system operators.

### BRIEF DESCRIPTION OF THE DRAWING FIGURE

Features and advantages of the present invention will become apparent to those skilled in the art from the description below, with reference to the following drawing figure, in which:

FIG. 1 is a schematic block diagram of the present-inventive system implementing a method for, via an Electronic Program Guide, making program recommendations based upon the user profiles of a particular user and other users with similar characteristics, all users being serviced by the same Service Provider.

### DESCRIPTION OF THE PREFERRED EMBODIMENTS

An Electronic Program Guide (EPG) in accordance with the preferred embodiment of the present invention provides a viewer/user with a list of recommended programs which has been constructed by a Service Provider and downloaded to the user's set-top box (or equivalent). The set-top box stores a User Profile with information about the viewer/user having dominion over the set-top box. The user can be an individual, or more than one, such as a family.

As an example, the recommended program list for a mid-twenties male with interests in sports, reality television, action-dramas, and comedies might be:

1. Sopranos

2. Real World

3. Monday Night Football

4. American Pie

5. Law & Order

The User Profile contains user identification or characteristic information, along with viewing history information. The viewer characteristic information can include the age of the viewer or age range of viewers, geographic location, gender, as well as some user-input preferences, such as program genres of interest, program ratings (e.g., MPAA rating system ratings) of interest, time preferences, program descriptions of interest or keywords or keyword combinations of program descriptions of interest, and others.

The viewing history information is a matter of design choice; however, in the preferred embodiment, the viewing history can include, for example, the previous 200 programs viewed. The programs can also be conveniently grouped according to genre, program description, and other characteristics.

Periodically or upon demand, user profiles for all of the viewers/users in the system are uploaded to the Service Provider. Either as a matter of default, or upon request by a user, the EPG can display a list of recommended programs predicted to be of interest to the user or users serviced by a set-top box. The recommended programs list is generated by the Service Provider and transmitted to the user's set-top box. The Service Provider generates the list by comparing the User Profile of the requesting viewer/user to that of other User Profiles. The Service Provider then surveys the viewing histories of the User Profiles of viewer/users having similar characteristics to the requesting viewer/user. As a result of the survey, the Service Provider generates a list of recommended programs that have or are likely to appeal to users of similar characteristics, and transmits the list to the requesting viewer/user's set-top box.

In a related alternate embodiment, the Service Provider modifies or supersedes the recommended programs list by listing programs according to agreement with content providers, and unbeknownst to users. For example, a content provider wishing to have his or her program widely viewed can through payment and agreement, have his or her program appear first on the recommended programs list of all of the viewers/users serviced by the Service Provider. The Recommended Programs List can automatically appear on the user's display at the beginning of each viewing session. Users would be more likely to at least initially tune-in to the recommended programs. As an additional value-added service, the Service Provider can highly recommend a particular content provider's program to those users who are more likely to have an interest.

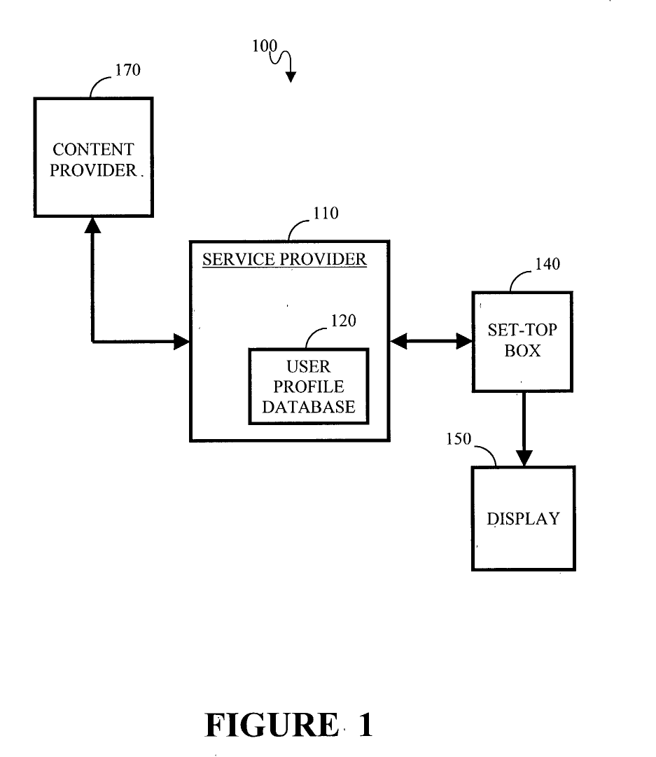

Having provided the general description above, a brief description will now be given of the system with reference to FIG. 1. The system 100 nominally includes a Service Provider 110 and many set-top boxes 140 serving system viewers/users. The set-top boxes 140 can be of the variety found in many cable or satellite television systems, with the ability to both receive and transmit information (such as user profiles). The set-top boxes 140 generate the EPGs used by the system, and place the programs received from the Service Provider in a format suitable for display on displays such as the one 150.

Among the many components of the Service Provider function, which are well known to those skilled in the art, are the novel inclusion of a User Profile database 120, for storing the user profiles of all of the users in the system. And, the system 100 also includes many program sources, such as the one 170 symbolically representing a content provider.

In addition to the foregoing, the system 100 of FIG. 1 is capable of generating recommendations for programs at least in part on the basis of provider- or advertiser-based preferences; i.e., an EPG that enables the system to inject a user-imperceptible preference or “bias” into the recommendation process, in return for payment or other consideration received by the system operators. For example, in exchange for receipt of payments from the Fox Television Network, the EPG might advance television shows from the Fox Network to a higher ordinal position in a list of recommendations to be presented to the television viewer. Alternatively, advancement to a higher ordinal position might occur in response to receipt of payment from a particular sponsor whose advertisements are placed in conjunction with particular television shows (e.g., Annheiser-Busch beer and National Football League television coverage) or programming from a particular network.

Variations and modifications of the present invention are possible, given the above description. However, all variations and modifications which are obvious to those skilled in the art to which the present invention pertains are considered to be within the scope of the protection granted by this Letters Patent.

What is claimed is:

1. A program navigation method for, via an Electronic Program Guide (EPG), enabling a program viewer/user to locate and link to programs, said method comprising the steps of:
a) via a service provider, providing a source of multiple programs;
b) via said service provider, gathering viewing history information regarding a plurality of viewers/users serviced by said service provider;
c) storing viewer/user profiles having viewer/user characteristic information and indicia of programs previously viewed by viewers/users serviced by said service provider;
d) providing program recommendation information to users, said program recommendation information being adapted to be converted and displayed via an EPG, and said program recommendation information at least comprising one program recommendation based upon a user's profile and at least one user profile of another user having predefined similarities in at least one user characteristic.

2. The method in claim 1, further comprising the steps of:
via a user's set-top box, compiling a user profile; and
via said set-top box, transmitting said user profile to said service provider upon demand.

3. The method in claim 1, further comprising the steps of:
via a user's set-top box, compiling a user profile; and
via said set-top box, transmitting said user profile to said service provider at predetermined times.

4. The method in claim 1, wherein said viewer/user characteristics include viewer/user age.

5. The method in claim 1, wherein said viewer/user characteristics include viewer/user gender.

6. The method in claim 1, wherein said viewer/user characteristics include viewer/user geographic location.

7. The method in claim 1, wherein said viewer/user characteristics include at least one viewer/user program preference.

8. The method in claim 1, further comprising the step of:
substituting the program recommendation information in step d) with program recommendation information to recommend programs according to agreement between said service provider and program content providers or agents of program content providers.

9. A program navigation system for, via an Electronic Program Guide (EPG), enabling a program viewer/user to locate and link to programs, said system comprising:
a) a service provider adapted to provide a source of multiple programs;
b) a viewing history information gatherer adapted to gather viewing history information regarding a plurality of viewers/users serviced by said service provider;
c) viewer/user profile storage adapted to store viewer/user profiles having viewer/user characteristic information and indicia of programs previously viewed by viewers/users serviced by said service provider;
d) a program recommendation information generator adapted to generate program recommendation information to users, said program recommendation information being adapted to be converted and displayed via an EPG, and said program recommendation information at least comprising one program recommendation based upon a user's profile and at least one user profile of another user having predefined similarities in at least one user characteristic.

10. The system in claim 9, further comprising:
a set-top box adapted to compile a user profile, and transmit said user profile to said service provider upon demand.

11. The system in claim 9, further comprising:
a set-top box adapted to compile a user profile, and transmit said user profile to said service provider at predetermined times.

12. The system in claim 9, wherein said viewer/user characteristics include viewer/user age.

13. The system in claim 9, wherein said viewer/user characteristics include viewer/user gender.

14. The system in claim 9, wherein said viewer/user characteristics include viewer/user geographic location.

15. The system in claim 9, wherein said viewer/user characteristics include at least one viewer/user program preference.

16. The system in claim 9, wherein said program recommendation information generator is further adapted to substitute the program recommendation information with program recommendation information to recommend programs according to agreement between said service provider and program content providers or agents of program content providers.
